(19) United States
(12) Patent Application Publication
(10) Pub. No.: US 2026/0341082 A1
(43) Pub. Date: Oct. 29, 2026

(54) SYSTEM AND METHOD OF CONTROLLING POWER OF AN ELECTRIC VEHICLE

(71) Applicant: Ford Global Technologies, LLC, Dearborn, MI (US)

(72) Inventors: Ben Thomas, Enfield (GB); Mike Rowland, Wickham Bishops (GB); Nicholas Dashwood Crisp, Benfleet (GB)

(21) Appl. No.: 19/190,490

(22) Filed: Apr. 25, 2025

(30) Foreign Application Priority Data
Apr. 11, 2024 (EP) 24169814

(51) Int. Cl. G07C 5/02; B60L 58/12

(52) U.S. Cl. CPC G07C 5/02; B60L 58/12

(57) ABSTRACT

The present disclosure relates to systems and methods for controlling power of an electric vehicle. As an example, a power control system of an electric vehicle includes an interface, a plurality of sensors, and a controller communicatively coupled to the plurality of sensors and the interface, the controller comprising non-transitory memory with instructions stored thereon that when executed cause the controller to receive feedback from the plurality of sensors to estimate a demanded power usage of the electric vehicle based on environmental and vehicle conditions, determine a current power usage of the electric vehicle, and display the current power usage next to the demanded power usage on the interface.

### CROSS REFERENCE TO RELATED APPLICATION

The present application claims priority to European Patent Application No. 24169814.1 filed on Apr.11, 2024. The entire contents of the above-listed application is hereby incorporated by reference for all purposes.

### FIELD

The present description relates generally to systems and methods for estimating and controlling demanded power usage of an electric vehicle. Particularly, but not exclusively, the present disclosure relates to a system and a method of controlling the power of an electric vehicle.

### BACKGROUND/SUMMARY

The demand for electric vehicles is increasing every day, due to their performance attributes and reduced emissions. However, sometimes it is difficult to achieve optimum operational efficiency of an electric vehicle due to driving style and/or ambient and external environmental conditions. There is demand to provide a system and a method to overcome the above-mentioned problem.

In one example, the issues described above may be addressed by a power control system of an electric vehicle including an interface, a plurality of sensors, and a controller communicatively coupled to the plurality of sensors and the interface, the controller comprising non-transitory memory with instructions stored thereon that when executed cause the controller to receive feedback from the plurality of sensors to estimate a demanded power usage of the electric vehicle based on environmental and vehicle conditions, determine a current power usage of the electric vehicle, and display the current power usage next to the demanded power usage on the interface.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1a illustrates a power control system of an electric vehicle, in accordance with some examples of the present disclosure;

FIG. 1b illustrates a power control system of an electric vehicle, in accordance with some examples of the present disclosure;

FIG. 2 illustrates a power control system of an electric vehicle, in accordance with some examples of the present disclosure;

FIG. 3a illustrates an interface for displaying an effect on the range for increased power usage of an electric vehicle, in accordance with some examples of the present disclosure;

FIG. 3b illustrates an interface for displaying the effect on the range for decreased power usage of an electric vehicle, in accordance with some examples of the present disclosure;

FIG. 4a illustrates an interface for displaying an indication for increased power usage of an electric vehicle, in accordance with some examples of the present disclosure;

FIG. 4b illustrates an interface for displaying an indication for decreased power usage of an electric vehicle, in accordance with some examples of the present disclosure;

FIG. 5 illustrates a flowchart of a method of controlling power of an electric vehicle, in accordance with some examples of the present disclosure; and

FIG. 6 illustrates a method for displaying the current power and demanded power on a display device, in accordance with some examples of the present disclosure.

### DETAILED DESCRIPTION

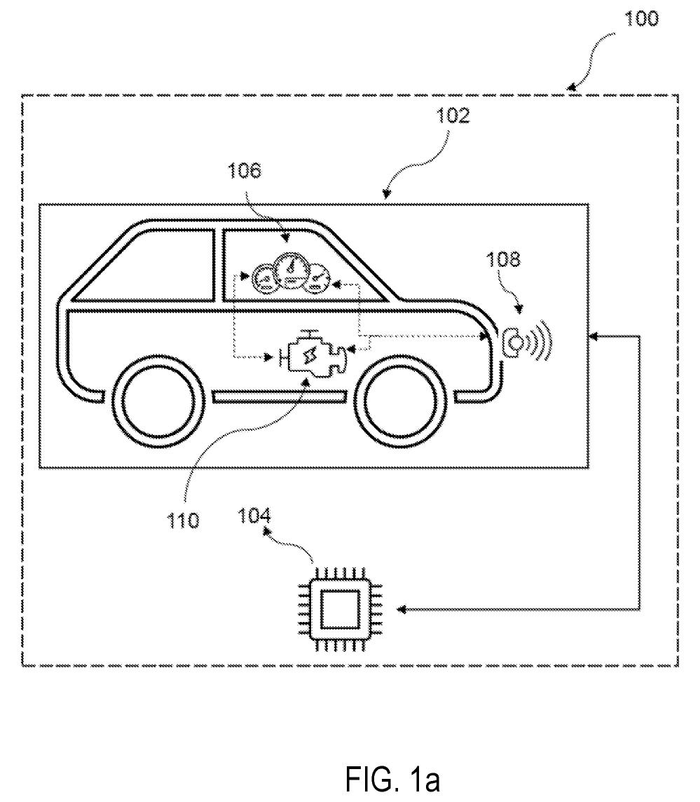

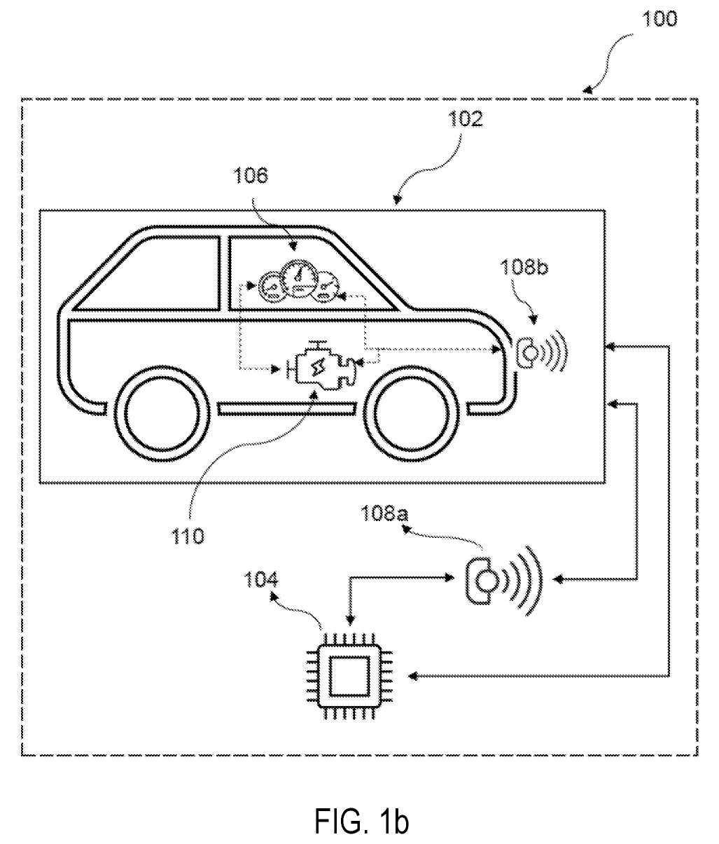

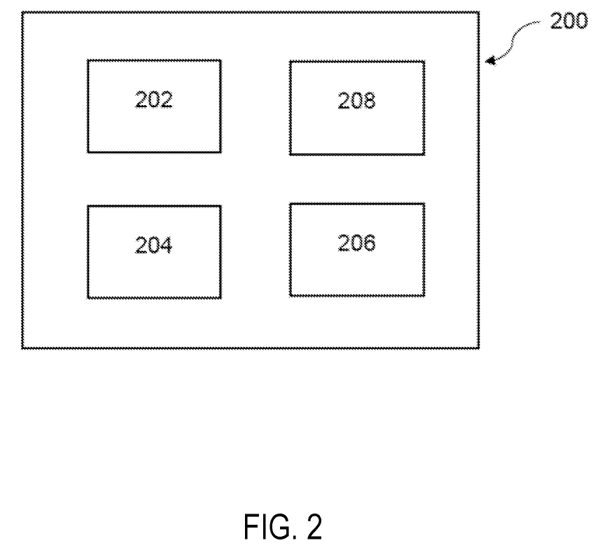

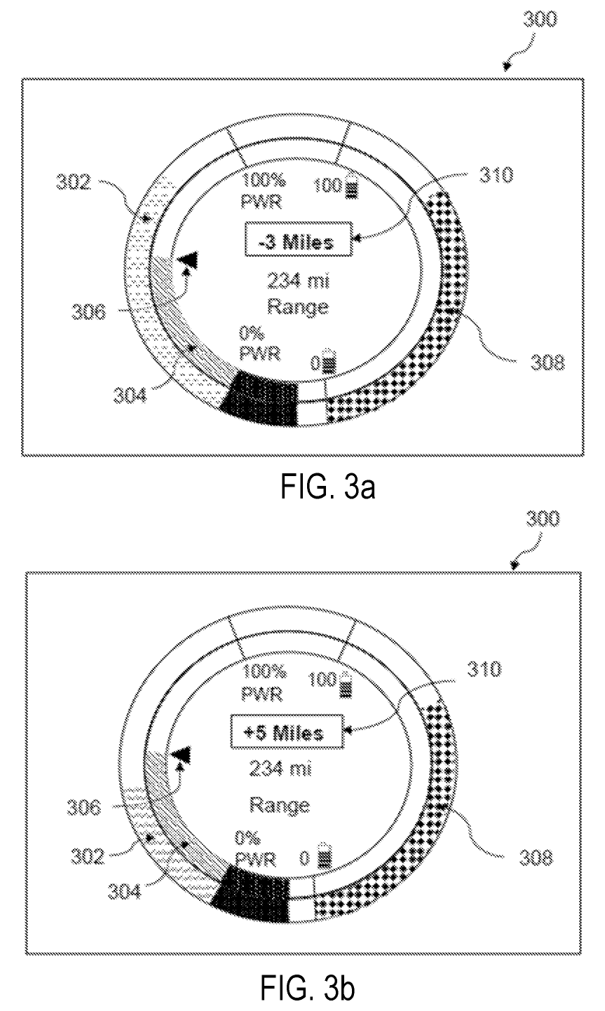

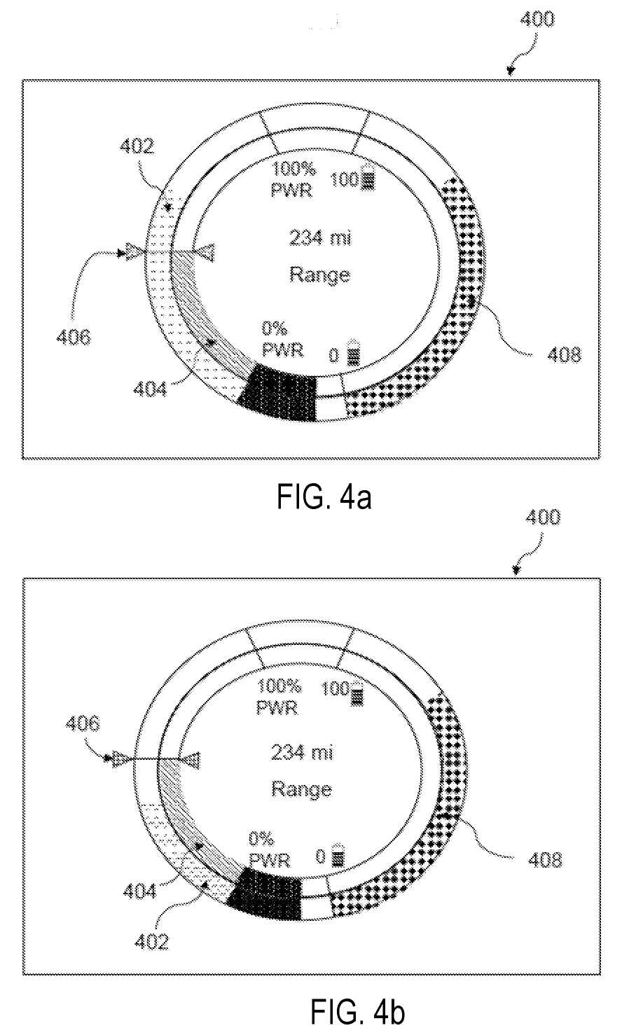

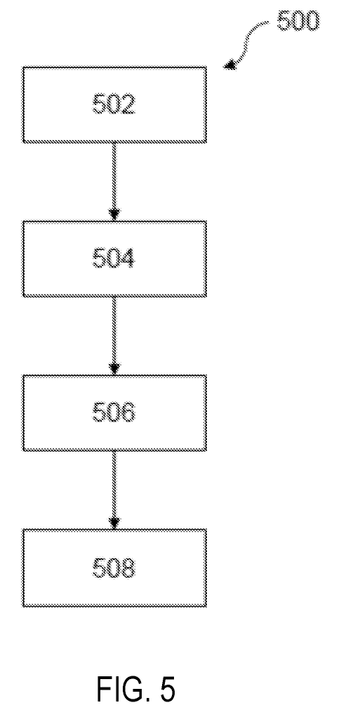

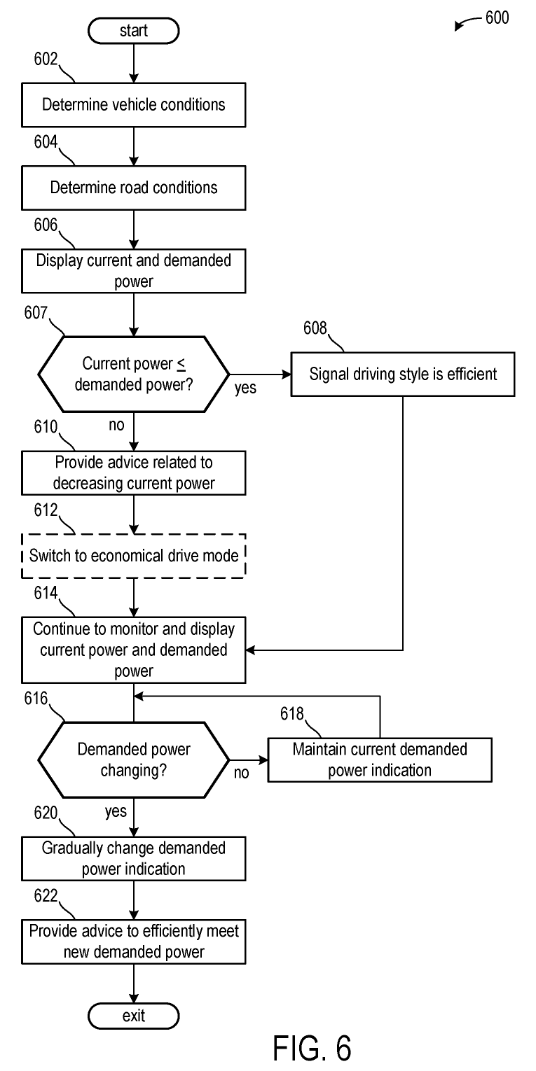

The following description relates to systems and methods for increasing an efficiency of an electric vehicle. FIG. 1a illustrates a power control system of an electric vehicle, in accordance with some examples of the present disclosure. FIG. 1b illustrates a power control system of an electric vehicle, in accordance with some examples of the present disclosure. FIG. 2 illustrates a power control system of an electric vehicle, in accordance with some examples of the present disclosure. FIG. 3a illustrates an interface for displaying an effect on the range for increased power usage of an electric vehicle, in accordance with some examples of the present disclosure. FIG. 3b illustrates an interface for displaying the effect on the range for decreased power usage of an electric vehicle, in accordance with some examples of the present disclosure. FIG. 4a illustrates an interface for displaying an indication for increased power usage of an electric vehicle, in accordance with some examples of the present disclosure. FIG. 4b illustrates an interface for displaying an indication for decreased power usage of an electric vehicle, in accordance with some examples of the present disclosure. FIG. 5 illustrates a flowchart of a method of controlling power of an electric vehicle, in accordance with some examples of the present disclosure. FIG. 6 illustrates a method for displaying the current power and demanded power on a display device, in accordance with some examples of the present disclosure.

The disclosure provides support for a system and a method for estimating and/or controlling the power of an electric vehicle.

The disclosure provides additional support for a system and a method for enabling efficient power usage of an electric vehicle.

The disclosure provides additional support for a system and a method for enhancing, e.g., maximizing, the range of an electric vehicle.

The disclosure provides additional support for a system and a method for indicating demanded power usage, e.g., to a driver, of an electric vehicle.

The disclosure provides additional support for a system and a method for enabling assessment of whether the current power usage exceeds the demanded power usage of an electric vehicle.

The disclosure provides additional support for a system and a method for enhancing the driver’s experience.

According to one aspect of the present disclosure, there is provided a power control system of an electric vehicle. The system includes an interface, a sensing circuitry e.g., of a sensing module, and a processing unit (e.g., a controller). The processing unit/controller may include memory with instructions stored thereon that when executed cause the processing unit/controller to adjust operation of the electric vehicle. The sensing module may include one or more of a sensor to detect at least one variable containing information about environmental and/or vehicle operational parameters. The processing unit may be configured to operate locally within the vehicle or is configured to operate remotely e.g., the processing unit is cloud based. The processing unit is communicatively coupled to the sensing module and the interface. The processing unit is configured to receive the value of at least one variable from the sensing module to estimate a demanded power usage (e.g., a minimum power usage demanded to meet the current or anticipated demands) of the electric vehicle and output at least one efficiency indication through the interface. In some examples, the variable may be a preset variable, an updated (or updateable) variable or a variable that is determined dynamically. The preset variable includes information related to the environmental and vehicle operational parameters, e.g., road conditions, weather conditions, vehicle conditions, vehicle aerodynamics, or a combination thereof. The preset variable may be a current value related to the environmental and vehicle operational parameters, or a predicted future value related to the environmental and vehicle operational parameters, e.g., based on a determined future route or usage of the vehicle. In some examples, the environmental and vehicle operational parameters may be updated dynamically. For example, information may be received from one or more road signs, sensor modules (e.g., satellite navigation), cloud databases, or other vehicles, e.g., in real time or near-real time, to indicate at least an environmental parameter. In some examples, the road conditions are updated e.g., dynamically, during the operation of the vehicle. For example, as the road construction or road material changes simultaneously along with the dynamic change in weather conditions.

In some examples, the processing unit determines an efficiency indication based on a comparison of the demanded power usage and a current power usage.

In some examples, the processing unit is communicatively coupled to a vehicle controller to receive a value of the current power usage.

In some examples, the sensing module includes at least one of an environmental parameter sensor, or a vehicle operational parameter sensor to determine the value of at least one preset variable.

In some examples, the at least one preset variable includes current road speed limit, road grade, current vehicle speed, vehicle mass, vehicle aerodynamics, current power usage, or a combination thereof.

In some examples, the efficiency indication includes range change indication, speed recommendation, road-load indication, driving mode indication, an efficiency performance summary, or a combination thereof. In some examples, the efficiency performance summary may be determined based on historic driving data of the vehicle, e.g., efficiency (and/or other operational parameter) over a period of operation of the vehicle.

According to one aspect of the present disclosure, there is provided a method of controlling power of an electric vehicle. The method comprises the steps of determining current power usage of the electric vehicle, estimating demanded power usage of the electric vehicle, comparing the current power usage and the demanded power usage, and outputting at least one efficiency indication based on the comparison. The step of estimating the demanded power usage comprises estimating a power usage using a value of at least one preset variable.

FIG. 1a illustrates a configuration of power control system 100 of an electric vehicle 102. The system 100 includes an electric vehicle 102, and a processing circuitry, e.g., a processing unit 104.

In some examples, the electric vehicle uses one or more electric motors for propulsion and powered using electricity from extravehicular sources, battery, or fuel cells. The electric vehicle is at least one of a Battery Electric Vehicle (BEV), Hybrid Electric Vehicle (HEV), Plug-in Hybrid Electric Vehicle (PHEV), or a Fuel Cell Electric Vehicle (FCEV). The BEVs are fully powered by electricity, whereas the HEVs use both an internal combustion engine (ICE) and a battery-powered motor. In HEVs, the ICE is used both to drive and charge when the battery is empty. The PHEVs use both an ICE and a battery charged from an external socket e.g., the vehicle’s battery can be charged with electricity rather than the engine. The FCEVs consume electric energy directly converted from chemical energy that is produced using fuel cells.

The electric vehicle 102 further includes an interface 106, a sensing circuitry e.g., of a sensing module 108, and a vehicle controller 110.

The processing unit 104 is communicatively coupled to the electric vehicle 102 and is configured to operate remotely. The processing unit 104 may be any commercially available processor or a cloud system. The processing unit 104 can also be implemented as a digital signal processor (DSP), a controller, a microcontroller, a designated system on chip (SoC), an integrated circuit implemented with a field programmable gate array (FPGA), an application specific integrated circuit (ASIC), or a combination thereof. The processing unit 104 is configured remotely to, for example, reduce the burden of operations on the electric vehicle, enable distributed computing, provide better accessibility, enhance scalability, collaborate efficiently, or upgrade productivity, thereby maintaining efficient performance. However, in some examples, the processing unit 104 may be provided on the electric vehicle 102 and include non-transitory memory that when executed enable the processing unit 104 to adjust one or more actuators of the electric vehicle 102.

In some examples, the processing unit 104 is configured for distributed computing enabling multiple devices to perform the calculations for the inputs received from the sensing module 108, or the vehicle controller 110.

In some examples, the electric vehicle 102 operates in a connected car configuration, thereby enabling bidirectional interaction between the electric vehicle 102 and the processing unit 104.

The interface 106 includes a display device, an audio device, a haptic feedback device, or other interfaces enabling driver and vehicle interaction. The display device may further include an odometer, a vehicle instrument cluster, a vehicle infotainment system, and/or a spatial display device.

The sensing module 108 includes at least one of an environmental parameter sensor, a vehicle operational parameter sensor, or a combination thereof, to determine the value of at least one preset variable.

The environmental parameter sensor includes but is not limited to a camera, global positioning system (GPS), navigation system, airflow sensors, radio detecting and ranging sensor (RADAR), or a combination thereof. The vehicle operational parameter sensor includes but is not limited to a battery parameter sensor, temperature sensor, voltage sensor, current sensor, steering sensor, tire pressure monitoring sensor (TPMS), pedal sensor, or a combination thereof. In some examples, the functionality of the vehicle operation parameter sensor may be realized through the vehicle controller 110.

The at least one preset variable includes an environmental parameter, a vehicle operational parameter, or a combination thereof. In some examples, the preset variable may be an updated (or updateable) variable or a variable that is determined dynamically.

The environmental parameter includes but is not limited to a current road speed limit, a road grade, a road material, road construction, curves, crossings, highway exits, junctions, traffic attributes, traffic lights, a weather condition, or a combination thereof. In some examples, the processing circuitry may access a database of environmental parameters, e.g., that is maintained by a highways agency. In some examples, the database of environmental parameters may be updated, e.g., dynamically, to reflect a current environmental parameter. For example, data may be received from one or more other vehicles, e.g., in real time or near-real time, to indicate a current environmental parameter of a road at the location of the one or more other vehicles.

The vehicle operational parameter includes but is not limited to a current vehicle speed, a vehicle mass, vehicle aerodynamics, a current power usage, a battery state of charge (SOC), a battery temperature, a tire pressure, a steering angle, a pedal pressure, or a combination thereof.

The vehicle aerodynamics includes resistive force or aerodynamic drag force value. The drag force is affected by the shape, structure, and size of the vehicle body and parts of the vehicle mounted over the exterior surface that include but are not limited to upfitter modifications, light bars, roof racks, mud flaps, rear spoiler, side mirrors, radio antenna, windshield wipers, ducts, or a combination thereof. In some examples, the aerodynamic drag force is determined using a road force estimator. The road force estimator calculates the force at the wheel used to maintain the vehicle speed, based on vehicle mass and road grade. In some examples, one or more vehicle operational parameters may be stored in a database. The database may be accessed by the processing circuitry to determine the vehicle aerodynamics. For example, a fleet operator may update a database of vehicle operational parameters based on a current configuration of a vehicle. For example, a fleet operator may update the database to include the current mass of a vehicle, either determined via load sensors or estimated, and/or whether a vehicle is currently fitted with one or more accessories, e.g., upfitter modifications, light bars, roof racks, etc. In some examples, the vehicle operational parameters may be updated, e.g., dynamically, during operation of a vehicle, e.g., as the load carried by a vehicle changes as cargo and/or passengers are loaded/unloaded.

The at least one preset variable is stored using at least one memory module. The memory module may include any of the volatile memory elements (for example, random access memory, such as DRAM, SRAM, SDRAM, etc.), non-volatile memory elements (for example, ROM, hard drive, etc.), other storage media or combinations thereof. The memory module may have a distributed architecture, where various components are situated remotely from one another. The software in the memory module may include one or more software programs, and machine learning algorithms, each of which includes an ordered listing of executable instructions for implementing logical functions. During operation, the sensing module 108 determines the value of at least one preset variable, e.g., environmental, or vehicle operational parameter. The sensing module 108 may store the value of at least one preset variable inside one or more memory modules (not shown here).

Based on the value of the at least one preset variable, the processing unit 104 estimates the demanded power usage (e.g., a power usage demanded to meet, within a threshold, an instantaneous or predicted near-time power usage) of the electric vehicle 102 based on environmental and vehicle conditions.

The processing unit 104 compares the demanded power usage with the current power usage of the electric vehicle, and outputs at least one efficiency indication through the interface 106. For example, the at least one efficiency indication may be an indication that the electric vehicle is operating at a current power that is a certain percentage, e.g., 5% or 10%, above the demanded power usage. Such an indication may not be evident based on analysis or inspection of the speed of the electric vehicle, since vehicle speed and power usage are not proportional. For example, traveling at 2 miles per hour (mph) above a speed limit, e.g., 72 mph in an area with a speed limit of 70 mph (approximately 2.8% over the speed limit), may result in the current power usage of the electric vehicle being 15% above the demanded power usage. As such, a small perceived speed differential may unduly infer a small power usage differential.

In some examples, the efficiency indication includes but is not limited to range impact indication, speed recommendation, road-load indication, driving mode indication, or a combination thereof.

In some examples, the range change indication is provided when the current power usage exceeds the demanded power usage, to enhance overall efficiency of the electric vehicle. In some examples, the range change indication is provided when the current power usage is less than the demanded power usage, enabling enhanced overall efficiency indication of the performance of the electric vehicle.

The speed recommendation, as an example of efficiency indication, provides recommendations to the driver regarding the increased or decreased speed with respect to the demanded power usage. The recommendation includes advice to alter the current vehicle speed to maintain or enhance the efficiency and range of the electric vehicle, e.g., by adjusting the current power usage to be within a threshold of the demanded power usage. In some examples, a driving mode may be engaged, e.g., using processing circuitry, to maintain the current vehicle speed within a predetermined threshold, e.g., based on a desired operation of the vehicle. In some examples, processing circuitry causes the vehicle speed to increase or decrease, e.g., automatically, based on the speed recommendation. For example, the processing circuitry may cause the vehicle speed to be adjusted or maintained to control the efficiency and range of the electric vehicle, e.g., by adjusting the current power usage to be within a threshold of the demanded power usage.

The road-load indication, as an example of efficiency indication, demonstrates a road-load indication arrow, displayed in a first pattern when the current power usage is less than the demanded power usage, and displayed in a second pattern when the current power usage exceeds the demanded power usage.

The driving mode indication, as an example of efficiency indication, provides advice, instruction and/or signal to modify (or cause to modify) the driving mode to conserve energy. For example, in case the current power usage exceeds the demanded power usage, and it is determined that the vehicle is being driven in sports driving mode, a driving mode indication may be provided to enable the driver to switch to an economy driving mode to maintain efficiency. The driving mode indication advises the driver of upcoming road features such as junctions, and curves. The indication may be displayed in the form of icons, to advise the driver to lift off from the throttle control. The driving mode indication in the form of icons may be combined with speed recommendation to advise a reduction in power as any specific road feature is approached, to provide context for the advice. In some examples, a driving mode may be engaged, e.g., by processing circuitry, based on the driving mode indication. For example, when the driving mode indication provides advice to modify the driving mode to conserve energy, processing circuitry may cause an efficient driving mode to be engaged. In some examples, this may occur when it is determined that a driver has ignored the indication, thereby intrusively activating the efficient driving mode.

In some examples, the efficiency indication is used for gamification purposes. Scores are collected and shared based on maintenance of the current power usage under a peak efficiency. Based on the collected and shared scores, the most efficient drivers are rewarded, to encourage efficient driving. In this way, driver’s may compete with one another to determine who may acquire a higher score.

In some examples, where processing circuitry causes one or more operational parameters of the vehicle, e.g., speed, to be controlled based on the efficiency indication, such control may be overridden, e.g., by an action of a driver and/or a fleet operator. For example, where processing circuitry causes a speed of the vehicle to be controlled, e.g., to with a certain threshold to maintain efficiency or range, such control may be overridden by operation of a vehicle throttle, e.g., by depressing a throttle control pedal beyond a certain limit.

The processing unit 104 is communicatively coupled to the sensing module 108, the interface 106, and the vehicle controller 110 using at least one of a wired or a wireless communication protocol.

The at least one wired communication protocol may include but is not limited to an ethernet (IEEE 802.3), a power line communication (PLC), a controller area network (CAN), a media-oriented system transport (MOST), or a flex Ray. The at least one wireless communication protocol may include but is not limited to radio frequency (RF), infrared (IrDA), Bluetooth, Zigbee (and other variants of the IEEE 802.15 protocol), a wireless fidelity (Wi-Fi) or IEEE 802.11 (any variation), IEEE 802.16 (WiMAX or any other variation), direct sequence spread spectrum (DSSS), frequency hopping spread spectrum (FHSS), global system for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication.

FIG. 1b illustrates another configuration of power control system 100 of an electric vehicle 102. The system 100 includes an electric vehicle 102, a processing unit 104, and an external sensing module 108a. The electric vehicle 102 further includes an interface 106, an internal sensing module 108b, and a vehicle controller 110. The external sensing module 108a is communicatively coupled to the electric vehicle 102.

The processing unit 104 is communicatively coupled to the electric vehicle 102 and the external sensing module 108a. The processing unit 104 is configured for remote operation. For example, the processing unit 104 is configured over a cloud network to enable distributed computing, efficient accessibility, and performance.

The internal sensing module 108b and the external sensing module 108a are configured to determine environmental and vehicle operational parameters that include but are not limited to a current road speed limit, a road grade, a road material, a road construction, curves, crossings, highway exits, junctions, traffic attributes, traffic lights, a current vehicle speed, a vehicle mass, vehicle aerodynamics, a current power usage, a battery SOC, a battery temperature, a tire pressure, a steering angle, a pedal pressure, or a combination thereof.

In some examples, the external sensing module 108a is configured to determine parameters including weather conditions, route conditions, or availability of next charging stations. The external sensing module 108a complements the processing unit 104, and the internal sensing module 108b, and enables vehicle-to-everything (V2X), vehicle-to-vehicle (V2V), vehicle-to-infrastructure (V2I), vehicle-to- pedestrian (V2P) communication capabilities, or a combination thereof.

The V2X, V2V, V2I, V2P, or a combination thereof enables real-time data exchange with nearby vehicles, bicycles, pedestrians, traffic lights, lane markers, parking meters, or a combination thereof to determine the upcoming environmental and road conditions, and accordingly alter the speed and power usage of the electric vehicle.

FIG. 2 illustrates a power control system 200 of an electric vehicle. The system 200 includes an interface 202, a sensing circuitry e.g., of a sensing module 204, a processing unit 206, and a vehicle controller 208.

In some examples, the interface 202 is implemented in the electric vehicle, e.g., at least one of interface 202, a sensing module 204, a processing unit 206, and a vehicle controller 208 may be a part of the electric vehicle. In some examples, the interface 202 and/or the processing unit 206 is configured for remote operation, e.g., at a location not associated with the electric vehicle, such as a control center for the electric vehicle (or a fleet of electric vehicles).

The interface 202 includes a display device, an audio device, a haptic feedback device, or other interfaces enabling driver and vehicle interaction. The display device may further include an odometer, a vehicle instrument cluster, a vehicle infotainment system, or a spatial display device.

The interface 202 may include a web-based application, an application program interface (API), a software application, or a combination thereof. The interface 202 may further include a plurality of sub-interfaces communicatively coupled to each other.

The sensing module 204 includes at least one of an environmental parameter sensor, a vehicle operational parameter sensor, or a combination thereof, to determine the value of at least one preset variable. In some examples, the preset variable may be an updated (or updateable) variable or a variable that is determined dynamically.

The processing unit 206 is communicatively coupled to the sensing module 204, the interface 202, and the vehicle controller 208. The processing unit 206 is configured to process the values received from the sensing module 204, the vehicle controller 208, or a combination thereof to implement functional aspects of the present disclosure. In some examples, the functionality of the processing unit 206 may be realized through the processing capability of the vehicle controller 208.

In some examples, the processing unit 206 is configured within the interface 202 and receives inputs from the sensing module 204, the vehicle controller 208, or a combination thereof.

The processing unit 206 may compare the demanded power usage with the current power usage of the electric vehicle, and outputs at least one efficiency indication through the interface 202.

In some examples, the processing unit 206 may output the efficiency indication in the form of an alert to an external interface (not shown) connected wired or wirelessly to the electric vehicle. The alert may include but is not limited to a pop up, notification, flashing light, audio signal, or a combination thereof.

The vehicle controller 208 is communicatively coupled to the sensing module 204 and provides at least one of the vehicle operational parameters to the sensing module 204. In some examples, the vehicle controller 208 is the same entity as that of the processing unit 206. In some examples, the vehicle controller 208 is installed in the vehicle and includes memory separate from memory of the processing unit 206. The processing unit 206 may signal to the vehicle controller 208 to adjust operating conditions of the vehicle.

In some examples, a temperature gauge (not shown here) is provided over the interface 202 to provide information about the thermal derate state of the electric vehicle, e.g., a battery of the electric vehicle. The temperature of the electric vehicle is monitored, and as the temperature increases, the power usage of the electric vehicle increases. The temperature gauge displays the monitored temperature of the electric vehicle and simultaneously displays the time left for the vehicle to derate, e.g., to remain within a predefined power range or below a predefined power value. The time left to derate decreases with the increase in temperature. Based on the temperature and time left to derate, an indication is provided for enhancing the performance of the electric vehicle and allows the driver to change driving behavior and alter current power usage, e.g., to mitigate a derate.

FIG. 3a illustrates an interface 300. The interface 300 displays current power usage indicator 302, demanded power usage indicator 304, a road load indication arrow 306, a battery status indicator 308, and a range change indication 310.

During vehicle operation, the current power usage indicator 302 and the demanded power usage indicator 304 are displayed along the road load indication arrow 306.

The battery status indicator 308 is displayed to provide information regarding the battery status of the electric vehicle, which may be associated with a SOC of the battery.

The range change indication 310 provides information to the driver about the effect on the range of the vehicle with respect to the power usage of the electric vehicle.

The range of the electric vehicle is derived based on factors that include but is not limited to a vehicle mass, a battery size, an electric motor specification, a driving style, road conditions and a road grade, environmental conditions, a road speed limit for a particular portion of a road, or a combination thereof.

As the current power usage indicator 302 exceeds the demanded power usage indicator 304, the efficiency indication changes adaptively and is displayed over the interface 300.

The road load indication arrow 306, as an example of efficiency indication, is adaptive to suggest the demanded power usage and is set according to the environmental and vehicle operational parameters.

The range change indication 310, as an example of efficiency indication, represents the lost or gained opportunity on the range of the electric vehicle. The range change indication 310 is displayed as negative in FIG. 3a, as the current power usage indicator 302 exceeds the demanded power usage indicator 304. The range change indication 310 is displayed as a distance, miles, or kilometers (km). In some examples, the range change indication 310 can be displayed as a percentage change in range.

To represent a reduction in the potential range of the electric vehicle, say, the electric vehicle is operating at a current power usage of e.g., 15 kWh, while the demanded power usage is e.g., 10 kWh. The electric vehicle provides an overall range of e.g., 5 miles at the demanded power usage, and while operating at current power usage, the overall range is reduced to e.g., 2 miles. Thus, the range change indication 310 is displayed as “-3 miles” to signify the lost opportunity on the range of the electric vehicle.

The effect on the range may be shown live to the driver during the vehicle operation or displayed in an overall trip summary. The overall trip summary includes a post-drive report disclosing power usage history, e.g., where the power/energy has been spent (propulsion, climate, or auxiliary loads). The post-drive report may additionally include an appreciation remark, e.g., ‘You saved 5 km by driving economically”.

The efficiency indication may also be displayed using various display patterns for the current power usage indicator 302, the demanded power usage indicator 304, or a combination thereof. For example, in FIG. 3a, a first pattern is displayed for the power usage indicator 302, when the current power usage is more than the demanded power usage, and, in FIG. 3b, a second pattern is displayed for the power usage indicator when the demanded power usage exceeds the current power usage.

In some examples, the first and second pattern are displayed as colors. The first pattern is displayed as green colors and the second pattern is displayed as red color.

FIG. 3b illustrates an interface 300. The interface 300 displays current power usage indicator 302, demanded power usage indicator 304, a road load indication arrow 306, a battery status indicator 308, and an effect on range indication 310.

The effect on range indication 310 is displayed as positive in FIG. 3b, as the current power usage indicator 302 is less than the demanded power usage indicator 304. The effect on range indication 310 is displayed as a distance, miles, or kilometers (km) that signifies an increased potential range of the electric vehicle. In some examples, the range effect indication 310 can be displayed as a percentage change in range.

For example, if the electric vehicle is operating at a 33.3% less current power usage compared to the demanded power usage. In such case, the electric vehicle provides an increased overall range of 25%, and the range effect indication 310 is displayed as “+25%” to signify the gained opportunity on the range of the electric vehicle.

In some examples, the first and second pattern are displayed as colors. The first pattern is displayed as green color and the second pattern is displayed as red color. Such displaying of feedback or indications using a pattern, e.g., color, enables the driver to conveniently identify and understand the indication while driving. The green color signifies positive feedback for increasing the potential range of the electric vehicle, and the red color signifies negative feedback for decreasing the potential range of the electric vehicle.

In some examples, the road load indication arrow 306 may disappear during deceleration. For example, when the electric vehicle is decelerating, the range indication 310 will display an increase in the range resultant on the power recovery during deceleration. For example, during deceleration, if the electric vehicle is operating at 6 kWh compared to the demanded power usage of 6.5 kWh, the range of the electric vehicle increases by 0.5 miles, for example. To represent the increased range of the electric vehicle, the range change indication 310 displays “+0.5 Miles”. In some example, at heavy decelerations (e.g., higher rates of deceleration), the power usage indicator 302 turns into a second pattern, as many heavy decelerations affect the efficiency of the electric vehicle. Hence, enabling the driver to enhance control of deceleration for increased efficiency and range of the vehicle.

FIGS. 4a and 4b illustrates an interface 400. The interface 400 displays current power usage indicator 402, demanded power usage indicator 404, a road load indication arrow 406, and a battery status indicator 408.

The road load indication arrow 406 is displayed in a first pattern when the demanded power usage indicator 404 exceeds the current power usage indicator 404, and when the current power usage indicator 402 exceeds the demanded power usage indicator 404, the road load indication arrow 406 is displayed in a second pattern.

In FIG. 4a, the road load indication arrow 406 is displayed in the second pattern, and in FIG. 4b, the road load indication arrow 406 is displayed in the first pattern.

The road load indication arrow 406 may be shown as at least one of the possible colour, outline, pattern, or shape, or a combination thereof.

In some examples, the first and second pattern are displayed as colors. The first pattern is displayed as green color and the second pattern is displayed as red color.

FIG. 5 illustrates a flowchart 500 for enabling efficient power usage of an electric vehicle which comprises steps of determining (502) current power usage of the electric vehicle, estimating (504) demanded power usage of the electric vehicle, comparing (506) the current power usage and the demanded power usage, and outputting (508) at least one efficiency indication based on the comparison. It should be noted that the process in FIG. 5, or any step thereof, could be performed on, or provided by, any of the devices shown in FIGS. 1a to 4b.

Instructions for carrying out method 500 may be executed by a controller based on instructions stored on a memory of the controller and in conjunction with signals received from sensors of the engine system, such as the sensors described above with reference to FIGS. 1a and 1b. The controller may employ engine actuators of the engine system.

The step of determining (502) the current power usage of the electric vehicle further comprises receiving the value of the current power usage from a vehicle controller. In some examples, the step of determining (502) comprises receiving a value of at least one preset variable from at least one of the sensing modules, or a vehicle controller, and processing the input to determine the current power usage.

The step of estimating (504) the demanded power usage comprises estimating a power usage using the value of at least one preset variable. The at least one preset variable includes an environmental parameter, a vehicle operational parameter, or a combination thereof. In some examples, the preset variable may be an updated (or updateable) variable or a variable that is determined dynamically.

The step of outputting (504) the at least one efficiency indication further comprises, outputting the efficiency indication using an interface that include but is not limited to a display device, an audio device, a haptic feedback device, or other interfaces enabling driver and vehicle interaction. The display device may further include an odometer, a vehicle instrument cluster, a vehicle infotainment system, or a spatial display device. Efficiency indication is provided using the interface configured in the electric vehicle, or the remote interface. The interface may include a web-based application, an application program interface (API), a software application, or a combination thereof. The interface may further include a plurality of sub-interfaces communicatively coupled to each other.

In some examples, the efficiency indication is provided in the form of an alert to an external interface wired or wirelessly coupled to the electric vehicle. The alert may include but is not limited to a pop up, a notification, a flashing light, an audio signal, or a combination thereof.

The step of outputting (504) the at least one efficiency indication includes outputting a range impact indication, a speed recommendation, a road-load indication, a driving mode indication, or a combination thereof.

In some examples, the range change indication is provided when the current power usage exceeds the demanded power usage, to enhance overall efficiency of the electric vehicle. In some examples, the range change indication is provided when the current power usage is less than the demanded power usage, enabling enhanced overall efficiency of the electric vehicle.

The speed recommendation, as an example of efficiency indication, provides recommendations to the driver regarding the increased or decreased speed with respect to the demanded power usage. The recommendation includes advice to alter the current vehicle speed to maintain or enhance the efficiency and range of the electric vehicle. For example, the advice is demonstrated using a pop-up, notification, flashing light, audio signal, or a combination thereof. In some examples, the pop-up or notification may additionally include, say “Lower down the speed by 5 km/h to achieve better efficiency” as a recommendation advice. In some examples, the flashing light is depicted in different patterns for increased and decreased speed. In some examples, the audio signal is output as distinct audio patterns for increased and decreased speed.

The road-load indication, as an example of efficiency indication, demonstrates a road-load indication arrow, displayed in a first pattern when the current power usage is less than the demanded power usage, and displayed in a second pattern when the current power usage exceeds the demanded power usage.

The driving mode indication, as an example of efficiency indication, provides advice to modify the driving mode to conserve energy. For example, in case the current power usage exceeds the demanded power usage, and it is determined that the vehicle is being driven in sports driving mode, a driving mode indication may be provided to enable the driver to switch to an economy driving mode to maintain efficiency.

Turning now to FIG. 6, it shows a method 600 for adjusting the demanded power usage indicator based on conditions. The method 600 begins at 602, which includes determining vehicle conditions. Vehicle conditions may include, but are not limited to, one or more of a current vehicle speed, a vehicle mass, vehicle aerodynamics, a current power usage, a battery state of charge (SOC), a battery temperature, a tire pressure, a steering angle, and a pedal pressure.

At 604, the method 600 may include determining road conditions. Road conditions may include one or more of to a current road speed limit, a road grade, a road material, road construction, curves, crossings, highway exits, junctions, traffic attributes, traffic lights, and a weather condition. The road conditions may be determined and/or sensed via a camera, global positioning system (GPS), navigation system, airflow sensors, radio detecting and ranging sensor (RADAR), or a combination thereof.

At 606, the method 600 may include displaying the current power and the demanded power. In one example, the current power and the demanded power may be displayed directly next to one another so that a vehicle operator may more easily visualize the two values.

At 607, the method 600 may include determining if the current power is less than or equal to the demanded power. If the current power is less than or equal to the demanded power, then at 608, the method 600 may include signaling that the current driving style is efficient. The method may further include not providing advice related to adjusting a driving style. Additionally, the current power indicator may be displayed as equal to the demanded power indicator.

Returning to 607, if the current power is not less than or equal to the demanded power, then current power consumption may be reducing a range of the electric vehicle. At 610, the method 600 may include providing advice related to decreasing current power. Advice may include adjusting one or more of a vehicle speed, a pedal pressure, cabin temperature settings, a window position, a position of an element attached to an exterior of the vehicle, and a tire pressure.

At 612, the method 600 may optionally include switching to an economical drive mode. The economical drive mode may include features that decrease power consumption. For example, an acceleration rate of the vehicle may be reduced in the economical drive mode. In one example, the economical drive mode may be selected by a vehicle operator. Alternatively, the economical drive mode may be automatically engaged without input from the vehicle operator. In some examples, the economical drive mode may only be automatically engaged in response to the battery SOC being less than a threshold SOC (e.g., 20%).

At 614, the method 600 may include continuing to monitor and display the current power and the demanded power. The current power and demanded power levels may be adjusted on the display as road and vehicle conditions change.

At 616, the method 600 may include determining if demanded power is changing. Demanded power may be changing if there is a change in one or more of a current road speed limit, a road grade, a road material, road construction, curves, crossings, highway exits, junctions, traffic attributes, traffic lights, and a weather condition. If demanded power is not changing, then at 618, the method 600 may include maintaining the current demanded power indication. As such, the display device may not be adjusted to indicated a new demanded power.

If the demanded power is changing, then at 620, the method 600 may include gradually changing the demanded power indication. Gradually changing the demanded power indication may be based on a desired change in vehicle operating dynamics such that noise, vibration, and harshness (NVH) and vehicle maneuvers are less experienced by the vehicle operator. For example, if the demanded power is reduced due to a reduction in a speed limit, the demanded power indication may slowly decrease to urge the vehicle operator to apply less pressure to a brake pedal relative to the demanded power indication rapidly changing to the new demanded power. By doing this, smoother changes in speed and vehicle maneuvers may occur, which may improve customer satisfaction.

At 622, the method 600 may include providing advice to meet the new demanded power. The advice may include when to brake, accelerate, turn, and the like. By doing this, the vehicle operator may focus on the driving environment rather than changes in the current power.

In some examples, such as in an autonomous vehicle, the advice provided by the system to improve vehicle efficiency may include adjusting occupant preferences to increase the vehicle efficiency. For example, the occupants may select less aggressive accelerations, reduced auxiliary device power consumption, and the like.

The disclosure also provides support for a power control system of an electric vehicle including an interface, a plurality of sensors, and a controller communicatively coupled to the plurality of sensors and the interface, the controller comprising non-transitory memory with instructions stored thereon that when executed cause the controller to: receive feedback from the plurality of sensors to estimate a demanded power usage of the electric vehicle based on environmental and vehicle conditions, determine a current power usage of the electric vehicle, and display the current power usage next to the demanded power usage on the interface. In a first example of the system, the instructions further cause the controller to display an efficiency metric on the interface based on a comparison of the current power usage to the demanded power usage. In a second example of the system, optionally including the first example, the plurality of sensors comprises two or more of a camera, global positioning system (GPS), a navigation system, airflow sensors, a radio detecting and ranging sensor (RADAR), a battery parameter sensor, a temperature sensor, a voltage sensor, a current sensor, a steering sensor, a tire pressure monitoring sensor (TPMS), and a pedal sensor. In a third example of the system, optionally including one or both of the first and second examples, demanded power usage is based on one or more of a current road speed limit, a road grade, a current vehicle speed, a vehicle mass, vehicle aerodynamics, and a current power usage. In a fourth example of the system, optionally including one or more or each of the first through third examples, the efficiency indication comprises one or more of a range impact indication, a speed recommendation, a road-load indication, a driving mode indication, and an efficiency performance summary. In a fifth example of the system, optionally including one or more or each of the first through fourth examples, the instructions further cause the controller to display advice corresponding to adjusting driver behavior to decrease a difference between the current power usage and the demanded power usage.

The disclosure also provides support for a method of an electric vehicle, the method including determining a current power usage of the electric vehicle, estimating a demanded power usage of the electric vehicle, comparing the current power usage and the demanded power usage, displaying the current power usage and the demanded power usage next to one another on a display device of the electric vehicle, and displaying an efficiency indication on the display device based on the comparison. In a first example of the method, the demanded power usage is based on one or more of an environmental parameter and a vehicle operational parameter. In a second example of the method, optionally including the first example, the environmental parameter comprises one or more of a current road speed limit, a road grade, a road material, road construction, curves, crossings, highway exits, junctions, traffic attributes, traffic lights, and a weather condition. In a third example of the method, optionally including one or both of the first and second examples, the vehicle operational parameter comprises one or more of a current vehicle speed, a vehicle mass, vehicle aerodynamics, a current power usage, a battery state of charge (SOC), a battery temperature, a tire pressure, a steering angle, and a pedal pressure. In a fourth example of the method, optionally including one or more or each of the first through third examples, the method further comprises: displaying advice to decrease a difference between the current power usage and the demanded power usage. In a fifth example of the method, optionally including one or more or each of the first through fourth examples, the method further comprises: estimating a change in the demanded power usage based on a change in one or more of an environmental parameter and a vehicle operational parameter, and wherein displaying the change in the demanded power usage comprises gradually adjusting the demanded power usage on a display from a previous demanded power usage to a new demanded power usage. In a sixth example of the method, optionally including one or more or each of the first through fifth examples, the method further comprises: providing a score based on the efficiency indication. In a seventh example of the method, optionally including one or more or each of the first through sixth examples, the method further comprises: displaying the score and other scores of other electric vehicles. In a eighth example of the method, optionally including one or more or each of the first through seventh examples, the method further comprises: automatically adjusting a drive mode based on the efficiency indication.

The disclosure also provides support for a system including a plurality of sensors, a display device arranged in an electric vehicle, and a controller with computer readable instructions stored on non-transitory memory thereof that when executed enable the controller to: determine a current power usage of the electric vehicle, determine a demanded power usage, display an efficiency of the electric vehicle based on a comparison of the current power usage to the demanded power usage on the display device, and display the current power usage next to the demanded power usage on the display device. In a first example of the system, the instructions further cause the controller to display an efficiency score of the electric vehicle along with efficiency scores of other electric vehicles on the display device. In a second example of the system, optionally including the first example, the instructions further cause the controller to adjust an operating mode of the electric vehicle to decrease the current power usage. In a third example of the system, optionally including one or both of the first and second examples, the instructions further cause the controller to display advice for decreasing the current power usage on the display device in response to the current power usage being greater than the demanded power usage. In a fourth example of the system, optionally including one or more or each of the first through third examples, the demanded power usage is based on one or more of an environmental parameter and a vehicle operational parameter, wherein the environmental parameter comprises one or more of a current road speed limit, a road grade, a road material, road construction, curves, crossings, highway exits, junctions, traffic attributes, traffic lights, and a weather condition, and wherein the vehicle operational parameter comprises one or more of a current vehicle speed, a vehicle mass, vehicle aerodynamics, a current power usage, a battery state of charge (SOC), a battery temperature, a tire pressure, a steering angle, and a pedal pressure.

The system and the method of the present disclosure is discussed with respect to the field of electric vehicles that include but are not limited to an electric bicycle, an electric car, or an electric bus throughout the description. However, the system and the method of the present disclosure may also be applied to electric locomotives, or electric aviation.

The above-stated descriptions are merely example implementations of this application but are not intended to limit the protection scope of this application. A person with ordinary skills in the art may recognize substantially equivalent structures or substantially equivalent acts to achieve the same results in the same manner or a dissimilar manner; the exemplary embodiment should not be interpreted as limiting the disclosure to one embodiment.

While aspects of the present disclosure have been described in detail with reference to the illustrated embodiments, those skilled in the art will recognize that many modifications may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and sub combinations of the preceding elements and features.

The description is provided for clarification purposes and is not limiting. Words and phrases are to be accorded their ordinary, plain meaning unless indicated otherwise.

FIGS. 1a-1b show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). to

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A power control system of an electric vehicle, comprising:
an interface;
a plurality of sensors; and
a controller communicatively coupled to the plurality of sensors and the interface, the controller comprising non-transitory memory with instructions stored thereon that when executed cause the controller to:
receive feedback from the plurality of sensors to estimate a demanded power usage of the electric vehicle based on environmental and vehicle conditions;
determine a current power usage of the electric vehicle; and
display the current power usage next to the demanded power usage on the interface.

2. The power control system of claim 1, wherein the instructions further cause the controller to display an efficiency indication on the interface based on a comparison of the current power usage to the demanded power usage.

3. The power control system of claim 1, wherein the plurality of sensors comprises two or more of a camera, global positioning system (GPS), a navigation system, airflow sensors, a radio detecting and ranging sensor (RADAR), a battery parameter sensor, a temperature sensor, a voltage sensor, a current sensor, a steering sensor, a tire pressure monitoring sensor (TPMS), and a pedal sensor.

4. The power control system of claim 1, wherein demanded power usage is based on one or more of a current road speed limit, a road grade, a current vehicle speed, a vehicle mass, vehicle aerodynamics, and a current power usage.

5. The power control system of claim 1, further comprising determining an efficiency based on a comparison of the current power usage and the determined power usage; and
displaying an efficiency indication based on the efficiency, wherein the efficiency indication comprises one or more of a range impact indication, a speed recommendation, a road-load indication, a driving mode indication, and an efficiency performance summary.

6. The system of claim 1, wherein the instructions further cause the controller to display advice corresponding to adjusting driver behaviour to decrease a difference between the current power usage and the demanded power usage.

7. A method of an electric vehicle, the method comprising:
determining a current power usage of the electric vehicle;
estimating a demanded power usage of the electric vehicle;
comparing the current power usage and the demanded power usage;
displaying the current power usage and the demanded power usage next to one another on a display device of the electric vehicle; and
displaying an efficiency indication on the display device based on the comparison.

8. The method of claim 7, wherein the demanded power usage is based on one or more of an environmental parameter and a vehicle operational parameter.

9. The method of claim 8, wherein the environmental parameter comprises one or more of a current road speed limit, a road grade, a road material, road construction, curves, crossings, highway exits, junctions, traffic attributes, traffic lights, and a weather condition.

10. The method of claim 9, wherein the vehicle operational parameter comprises one or more of a current vehicle speed, a vehicle mass, vehicle aerodynamics, the current power usage, a battery state of charge (SOC), a battery temperature, a tire pressure, a steering angle, and a pedal pressure.

11. The method of claim 7, further comprising displaying advice to decrease a difference between the current power usage and the demanded power usage.

12. The method of claim 7, further comprising estimating a change in the demanded power usage based on a change in one or more of an environmental parameter and a vehicle operational parameter, and wherein displaying the change in the demanded power usage comprises gradually adjusting the demanded power usage on a display from a previous demanded power usage to a new demanded power usage.

13. The method of claim 7, further comprising providing a score based on the efficiency indication.

14. The method of claim 13, further comprising displaying the score and other scores of other electric vehicles.

15. The method of claim 7, further comprising automatically adjusting a drive mode based on the efficiency indication.

16. A system, comprising:
a plurality of sensors;
a display device arranged in an electric vehicle; and
a controller with computer readable instructions stored on non-transitory memory thereof that when executed enable the controller to:
determine a current power usage of the electric vehicle;
determine a demanded power usage;
display an efficiency of the electric vehicle based on a comparison of the current power usage to the demanded power usage on the display device; and
display the current power usage next to the demanded power usage on the display device.

17. The system of claim 16, wherein the instructions further cause the controller to display an efficiency score of the electric vehicle along with efficiency scores of other electric vehicles on the display device.

18. The system of claim 16, wherein the instructions further cause the controller to adjust an operating mode of the electric vehicle to decrease the current power usage.

19. The system of claim 16, wherein the instructions further cause the controller to display advice for decreasing the current power usage on the display device in response to the current power usage being greater than the demanded power usage.

20. The system of claim 16, wherein the demanded power usage is based on one or more of an environmental parameter and a vehicle operational parameter, wherein the environmental parameter comprises one or more of a current road speed limit, a road grade, a road material, road construction, curves, crossings, highway exits, junctions, traffic attributes, traffic lights, and a weather condition, and wherein the vehicle operational parameter comprises one or more of a current vehicle speed, a vehicle mass, vehicle aerodynamics, the current power usage, a battery state of charge (SOC), a battery temperature, a tire pressure, a steering angle, and a pedal pressure.
